(19) United States
(12) Patent Application Publication
(10) Pub. No.: US 2025/0186818 A1
(43) Pub. Date: Jun. 12, 2025

(54) COMPRESSED AIR FOAM GENERATING DEVICE THAT CREATES FOAM WITH HIGH FIRE-EXTINGUISHING CAPABILITIES

(71) Applicant: Timothy R. Rowe, Hope, AR (US)

(72) Inventor: Timothy R. Rowe, Hope, AR (US)

(21) Appl. No.: 18/533,201

(22) Filed: Dec. 8, 2023

(51) Int. Cl. A62C 5/02; B01F 23/235

(52) U.S. Cl. CPC A62C 5/024; B01F 23/235

(57) ABSTRACT

A foam generating device that maximizes the fire extinguishing capabilities of fluorine-free foam solutions. An air bubble injector placed in a central region of a flow of water and surfactant through a pipe forces air forward and rearward out from the center of the air bubble injector in two curtains of air, thereby creating 360 degree vortexes, so all the water with surfactant flowing through the pipe will be suffused with air bubble streams folding into each other at high speed, thereby creating a dense tough bubble foam that retains its “drain time” when applied to a fire, resulting in faster fire extinguishment, and less exposure of the fire fighter to carcinogens. The foam generating device helps reduce the amount of foam used for fire extinguishment, thereby reducing environmental impact from toxic run-off. The air bubble injector can be made from all stainless steel.

### FIELD OF THE INVENTION

This invention relates generally to compressed air foam devices, and more particularly to compressed air foam devices for use with fluorine-free foam for fire-fighting.

### BACKGROUND OF THE INVENTION

A surfactant is a detergent or a soap. Fluorine-free foam (FFF, also called F3) is a synthetic-based foam that contains surfactant blends, and possibly also polysaccharides. Fluorine-free foam provides a blanket of bubbles above fire fuels, and cools them so as to extinguish fires quickly. Contrary to foams containing fluorine, fluorine-free foams do not persist in the environment, and consequently do not bio-accumulate or cause toxic effects. Therefore, Fluorine-free foam effluents do not need to be treated in a waste incineration plant.

Fluorine-free foam consists of water, solvents, and hydrocarbon surfactants, to the exclusion of per- and polyfluoroalkyl substances (PFAS or PFASs). PFAS are a group of synthetic organo-fluorine chemical compounds that have multiple fluorine atoms attached to an alkyl group. Since there aren't any PFAS in fluorine-free foam, fluorine-free foam doesn't form an aqueous film to extinguish fires. Instead, fluorine-free foam relies on a blanket of bubbles. However, this blanket of bubbles has been proven to be slightly less effective than aqueous film forming foams (AFFFs), so fluorine-free foams require higher expansion rates to boost efficacy.

### SUMMARY OF THE INVENTION

The Foam Generating Device of the invention maximizes the fire extinguishing capabilities of the new fluorine-free foam solutions now available.

By placing an air bubble injector in a central region of the flow of water and surfactant, and by forcing air out from the center of the air bubble injector in two curtains of air, thereby creating 360 degree vortexes, so all the water with surfactant flowing through the pipe will be treated with air folding into each other at high velocity, a dense tough bubble foam forms that retains its “drain time” when applied to the fire, thereby resulting in faster fire extinguishment, and less exposure of the fire fighter to carcinogens.

Thus, the Foam Generating Device of the invention helps reduce the amount of foam used for fire extinguishment, thereby reducing environment impact from toxic run-off from the fire.

The Foam Generating Device of the invention creates a rapid flow of Florine-free foam that maximize fire extinguishing capabilities, while using reducing the amount of foam required, thereby helping to protect the environment from toxic run-off from fires.

By placing the air bubble injector in a central region of the flow of water and surfactant, and flowing air to the outside of the pipe, the surfactant solution is completely treated with two 360 degree vortexes of air. This creates two curtains of air that are each directed at the other, thereby causing a vacuum that creates a turbulent flow that violently mixes the air and surfactant solution together. This creates very many small consistently-sized bubble structures that extinguish fires faster and more safely than other compressed air foam systems.

The air inlet is ½″ and shrinks down to 7/32″ so as to allow for a flow rate of 60 cubic feet per minute (CFM) at approximately 100 pounds per square inch (PSI) of air pressure.

The two 360-degree air discharges have five 1/16″ holes, evenly spaced around, as shown in the third picture below.

The device can be made from all stainless steel.

A general aspect of the invention is a compressed air foam generating device that maximizes the fire-extinguishing capabilities of fluorine-free foam solutions. The device includes: a pipe having a first opening configured to accommodate a water and surfactant input flow, a second opening configured to accommodate a foam output flow, at least one compressed air inlet configured to enable a compressed air flow from outside the pipe to inside the pipe; and an air bubble injector, in fluid communication with the at least one compressed air inlet, configured to transform the compressed air flow into a plurality of streams of air bubbles injected into the water and surfactant input flow. The air bubble injector includes: a compressed air input port; a central air manifold having a first plurality of bubble injectors that inject forward bubbles with respect to the compressed air flow, and a second plurality of bubble injectors that inject rearward bubbles with respect to the compressed air flow; a rearward vortex generating ramp configured to deflect the rearward bubbles outward as a rearward vortex into the water and surfactant input flow, the rearward vortex generating ramp in fluid communication with the compressed air input port and the central air manifold to permit a flow of compressed air from the compressed air input port to the central air manifold; a forward vortex generating ramp configured to deflect the forward bubbles outward as a forward vortex of bubbles into the water and surfactant input flow; and a flow deflector, attached to the forward vortex generating ramp, the flow deflector having a surface configured to reduce fluid drag as the water and surfactant input flow impinge upon the air bubble injector, the forward vortex of bubbles turbulently comingling with the rearward vortex of bubbles in the water and surfactant input flow so as to produce a foam output flow having high bubble density, resulting in prolonged drain time when applied to a fire, thereby providing faster fire extinguishment.

In some embodiments, the air bubble injector is located in a radially central region of the pipe.

In some embodiments, the forward vortex generating ramp is curved such that the forward vortex generating ramp has greater slope as a function of distance from the central air manifold.

In some embodiments, the rearward vortex generating ramp is curved such that the rearward vortex generating ramp has greater slope as a function of distance from the central air manifold.

In some embodiments, the forward vortex generating ramp is curved such that the forward vortex generating ramp has greater slope as a function of distance from the central air manifold.

In some embodiments, the rearward vortex generating ramp and the forward vortex generating ramp are mirror images of each other about a central plane of the central air manifold.

In some embodiments, the pipe has first and second compressed air inlets, each compressed air inlet configured to enable a compressed air flow from outside the pipe to inside the pipe, the air bubble injector in fluid communication with the first compressed air inlet, the device further including a second air bubble injector, in fluid communication with the second compressed air inlet.

Another general aspect of the invention is an air bubble injector for use in a compressed air foam generating device, the air bubble injector maximizing the fire-extinguishing capabilities of fluorine-free foam solutions. The air bubble injector includes: a compressed air input port; a central air manifold having a first plurality of bubble injectors that inject forward bubbles with respect to the compressed air flow, and a second plurality of bubble injectors that inject rearward bubbles with respect to the compressed air flow; a rearward vortex generating ramp configured to deflect the rearward bubbles outward as a rearward vortex into the water and surfactant input flow, the rearward vortex generating ramp in fluid communication with the compressed air input port and the central air manifold to permit a flow of compressed air from the compressed air input port to the central air manifold; a forward vortex generating ramp configured to deflect the forward bubbles outward as a forward vortex of bubbles into the water and surfactant input flow; and a flow deflector, attached to the forward vortex generating ramp, the flow deflector having a surface configured to reduce fluid drag as the water and surfactant input flow impinge upon the air bubble injector. The forward vortex of bubbles turbulently comingles with the rearward vortex of bubbles in the water and surfactant input flow so as to produce a foam output flow having high bubble density, resulting in prolonged drain time when applied to a fire, thereby providing faster fire extinguishment.

In some embodiments, the forward vortex generating ramp is curved such that the forward vortex generating ramp has greater slope as a function of distance from the central air manifold.

In some embodiments, the rearward vortex generating ramp is curved such that the rearward vortex generating ramp has greater slope as a function of distance from the central air manifold.

In some embodiments, the forward vortex generating ramp is curved such that the forward vortex generating ramp has greater slope as a function of distance from the central air manifold.

In some embodiments, the rearward vortex generating ramp and the forward vortex generating ramp are mirror images of each other about a central plane of the central air manifold.

### BRIEF DESCRIPTION OF THE DRAWINGS

Many additional features and advantages will become apparent to those skilled in the art upon reading the following description, when considered in conjunction with the accompanying drawings, wherein:

FIG. 1 is a cutaway side view of an embodiment of the compressed air foam generating device, showing a pipe having an opening for receiving an input flow of water and surfactant, and an opposite opening to accommodate a foam output flow, also showing a compressed air inlet to provide a compressed air flow to an air bubble injector.

FIG. 2A is a cutaway side view of the embodiment of the air bubble injector of FIG. 1, showing a central air manifold that centrally receives compressed air, the central air manifold having a first and second plurality of bubble injectors, as well as respective forward and rearward vortex generating ramps that deflect forward and rearward bubbles outward, and a flow deflector that reduces fluid drag as the water and surfactant input flow impinge upon the air bubble injector.

FIG. 2B is an isometric view of the air bubble injector of FIG. 1, showing the first plurality of bubble injectors, and the rearward vortex generating ramp that deflects rearward bubbles outward into the water and surfactant input flow, also showing the flow deflector having a surface configured to reduce fluid drag as the water and surfactant input flow impinge upon the air bubble injector.

FIG. 3 is a side view of the pipe of FIG. 1, the pipe enclosing the compressed air foam generating device, also showing the opening for receiving an input flow of water and surfactant, and the opposite opening to accommodate a foam output flow, as well as the compressed air inlet that provides a compressed air flow to the air bubble injector.

FIG. 4 is a cutaway side view of the embodiment of the compressed air foam generating device of FIG. 1, showing the pipe receiving an input flow of water and surfactant from the left, and showing the opposite opening providing an output flow of foam to the right, also showing the compressed air inlet that is providing a compressed air flow to the central air manifold that has the first and second plurality of bubble injectors providing forward and rearward bubbles, respectively, that are deflected outward by respective forward and rearward vortex generating ramps, also showing the flow deflector that reduces fluid drag as the input flow of water and surfactant impinge upon the air bubble injector.

FIG. 5 is a cutaway side view of an embodiment having two air bubble injectors, showing a pipe with a bell reducer, the pipe having an opening for receiving an input flow of water and surfactant, and an opposite opening to accommodate a foam output flow, also showing two compressed air inlets that provide a compressed air flow to each of the two air bubble injectors.

FIG. 6 is a front view of the embodiment of FIG. 5, showing one of the two air bubble injectors, as well as showing a mounting plate for connecting the pipe to a supply of pressurized water, and the two compressed air inlets that provide a compressed air flow to each of the two air bubble injectors.

### DETAILED DESCRIPTION

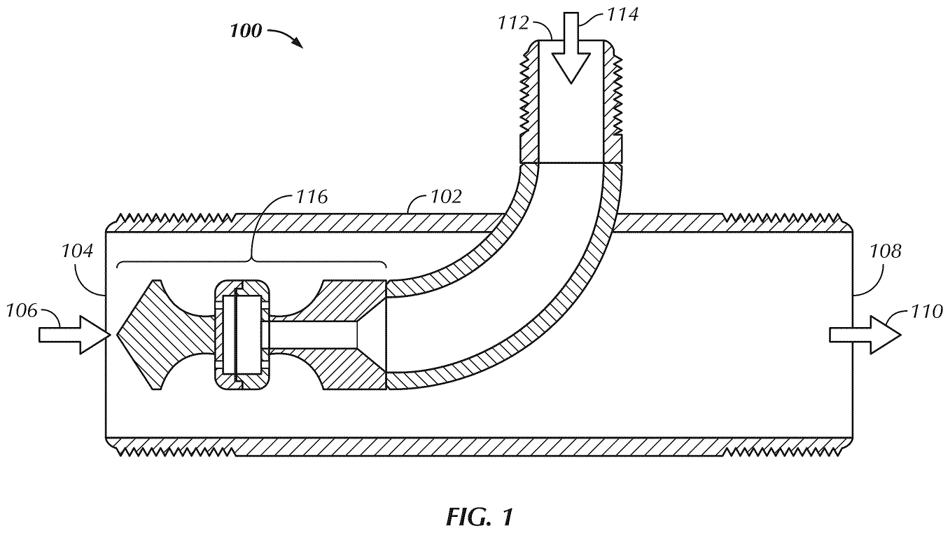

With reference to FIG. 1, a cutaway side view is shown of an embodiment 100 of the compressed air foam generating device. This embodiment 100 includes a pipe 102 having an externally threaded opening 104 for receiving an input flow 106 of water and surfactant, and an opposite externally threaded opening 108 to accommodate a foam output flow 110, also showing an externally threaded compressed air inlet 112 to provide a compressed air flow 114 to an air bubble injector 116.

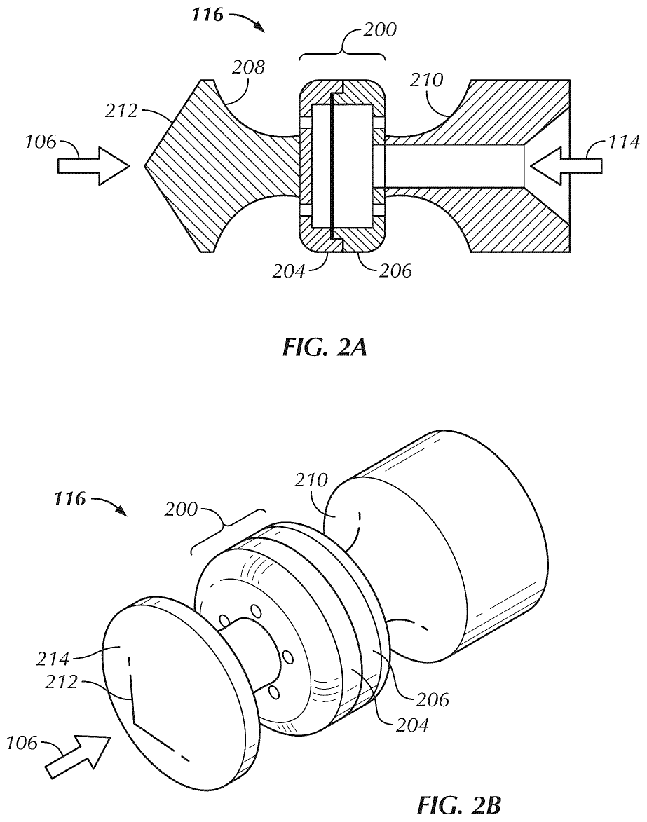

Referring to FIG. 2A, a cutaway side view is shown of the embodiment 116 of the air bubble injector 116 of FIG. 1, showing a central air manifold 200 that centrally receives a flow 202 of compressed air, the central air manifold 200 having a first 204 and second 206 plurality of bubble injectors, as well as respective forward 208 and rearward 210 vortex generating ramps that deflect forward and rearward bubbles (not shown) outward, and a flow deflector 212 that reduces fluid drag as the water and surfactant input flow 106 impinge upon the air bubble injector 116.

With reference to FIG. 2B, an isometric view of the air bubble injector 116 of FIG. 1 shows the first plurality 204 of bubble injectors, and the rearward 210 vortex generating ramp that deflects rearward bubbles (not shown) outward into the water and surfactant input flow 106. FIG. 2B also shows the flow deflector 212 having a surface 214 configured to reduce fluid drag as the water and surfactant input flow 106 impinge upon the air bubble injector.

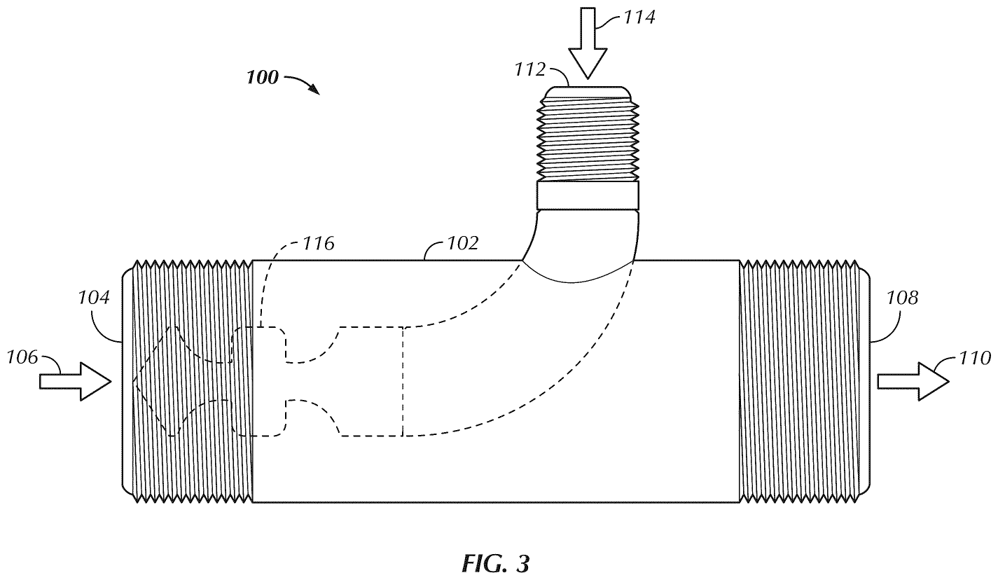

Referring to FIG. 3, a side view of the pipe of FIG. 1 is presented, showing the pipe 102 that encloses the air bubble injector 116, also showing the opening 104 for receiving an input flow 106 of water and surfactant, and the opposite opening 108 to accommodate a foam output flow 110, as well as the compressed air inlet 112 that provides a compressed air flow 114 to the air bubble injector 116.

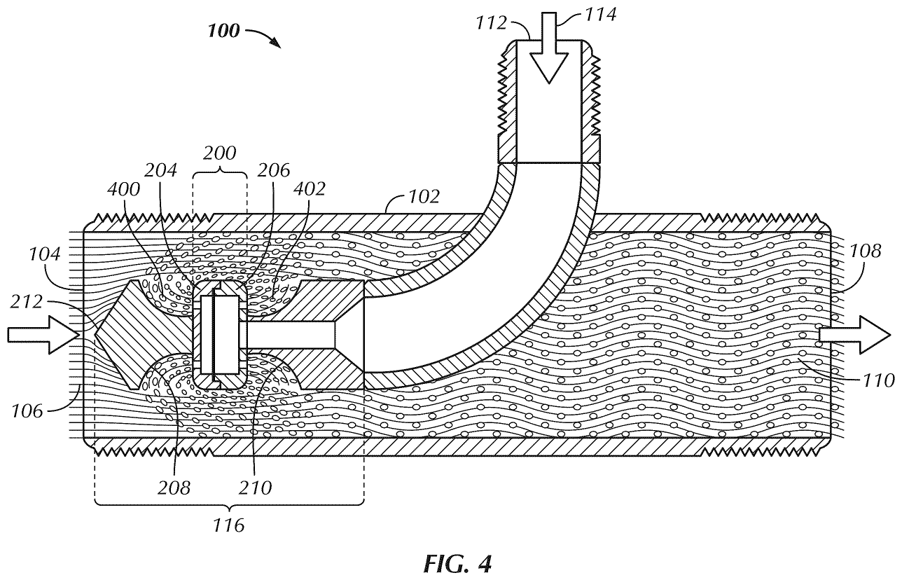

With reference to FIG. 4, a cutaway side view is shown of the embodiment of the compressed air foam generating device 100 of FIG. 1, more explicitly illustrating bubble generation. FIG. 4 shows the pipe 102 receiving an input flow 106 of water and surfactant from the left, and showing the opposite opening 108 providing an output flow 110 of foam to the right, also showing the compressed air inlet 112 that is providing a compressed air flow 114 to the central air manifold 200. The central air manifold 200 includes the first 204 and second 206 plurality of bubble injectors providing forward 400 and rearward 402 bubbles, respectively, that are deflected outward by respective forward 208 and rearward 210 vortex generating ramps, also showing the flow deflector 212 that reduces fluid drag as the input flow 106 of water and surfactant impinge upon the air bubble injector 116.

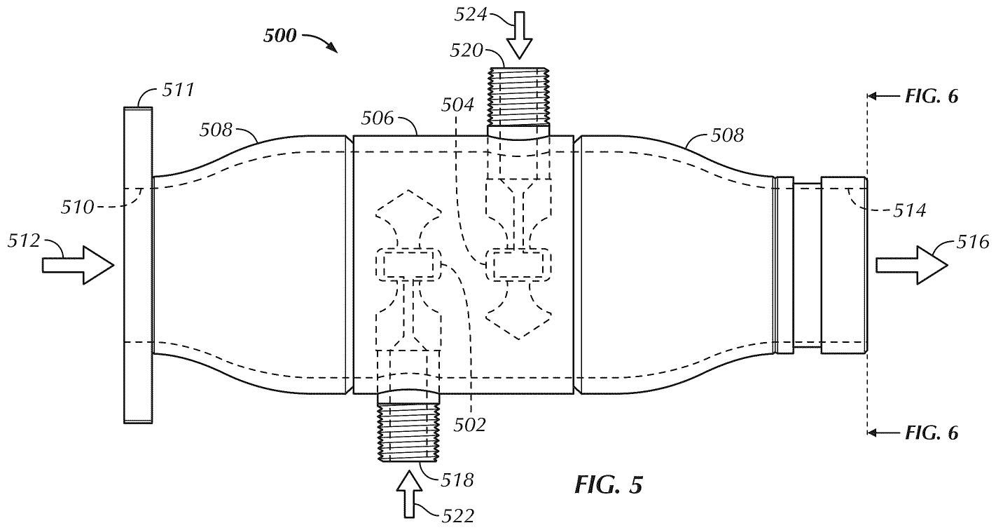

Referring to FIG. 5, a cutaway side view of another embodiment 500 having two air bubble injectors 502, 504, showing a pipe 506 with a bell reducer 508, the pipe 506 having an opening 510 with a mounting plate 511, the opening 510 being for receiving an input flow 512 of water and surfactant. Also shown is an opposite opening 514 to accommodate a foam output flow 516, and two compressed air inlets 518, 520 that provide a compressed air flow 522, 524, respectively, to each of the two air bubble injectors 502, 504.

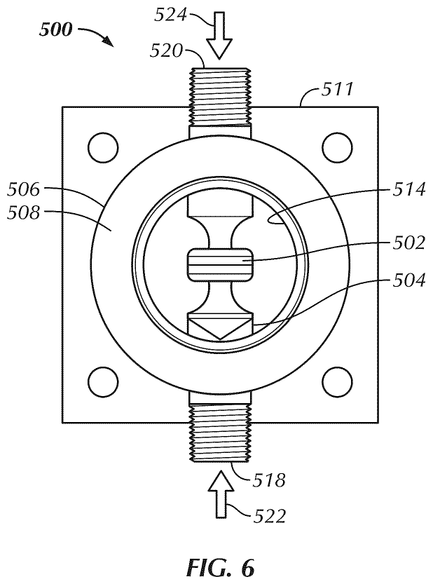

With reference to FIG. 6, a front view of the embodiment 500 of FIG. 5 is shown. One of the two air bubble injectors 504 can be seen through the opening 514. A mounting plate 511 for connecting the pipe 506 to a supply of pressurized water (not shown), and the two compressed air inlets 518, 520 that provide a compressed air flow 522, 524 to each of the two air bubble injectors 502, 504, respectively.

Other modifications and implementations will occur to those skilled in the art without departing from the spirit and the scope of the invention as claimed. Accordingly, the above description is not intended to limit the invention, except as indicated in the following claims.

What is claimed is:

1. A compressed air foam generating device to maximize the fire-extinguishing capabilities of fluorine-free foam solutions, the device comprising:
a pipe having a first opening configured to accommodate a water and surfactant input flow, a second opening configured to accommodate a foam output flow, and at least one compressed air inlet configured to enable a compressed air flow from outside the pipe to inside the pipe; and
an air bubble injector, in fluid communication with the at least one compressed air inlet, configured to transform the compressed air flow into a plurality of streams of air bubbles injected into the water and surfactant input flow, the air bubble injector having:
a compressed air input port;
a central air manifold having a first plurality of bubble injectors that inject forward bubbles with respect to the compressed air flow, and a second plurality of bubble injectors that inject rearward bubbles with respect to the compressed air flow;
a rearward vortex generating ramp configured to deflect the rearward bubbles outward as a rearward vortex into the water and surfactant input flow, the rearward vortex generating ramp in fluid communication with the compressed air input port and the central air manifold to permit a flow of compressed air from the compressed air input port to the central air manifold;
a forward vortex generating ramp configured to deflect the forward bubbles outward as a forward vortex of bubbles into the water and surfactant input flow; and
a flow deflector, attached to the forward vortex generating ramp, the flow deflector having a surface configured to reduce fluid drag as the water and surfactant input flow impinge upon the air bubble injector,
the forward vortex of bubbles turbulently comingling with the rearward vortex of bubbles in the water and surfactant input flow so as to produce a foam output flow having high bubble density, resulting in prolonged drain time when applied to a fire, thereby providing faster fire extinguishment.

2. The device of claim 1, wherein the air bubble injector is located in a radially central region of the pipe.

3. The device of claim 1, wherein the forward vortex generating ramp is curved such that the forward vortex generating ramp has greater slope as a function of distance from the central air manifold.

4. The device of claim 1, wherein the rearward vortex generating ramp is curved such that the rearward vortex generating ramp has greater slope as a function of distance from the central air manifold.

5. The device of claim 1, wherein the forward vortex generating ramp is curved such that the forward vortex generating ramp has greater slope as a function of distance from the central air manifold.

6. The device of claim 1, wherein the rearward vortex generating ramp and the forward vortex generating ramp are mirror images of each other about a central plane of the central air manifold.

7. The device of claim 1, wherein the pipe has first and second compressed air inlets, each compressed air inlet configured to enable a compressed air flow from outside the pipe to inside the pipe, the air bubble injector in fluid communication with the first compressed air inlet, the device further including:
a second air bubble injector, in fluid communication with the second compressed air inlet.

8. An air bubble injector for use in a compressed air foam generating device, the air bubble injector maximizing the fire-extinguishing capabilities of fluorine-free foam solutions, the air bubble injector comprising:
a compressed air input port;
a central air manifold having a first plurality of bubble injectors that inject forward bubbles with respect to the compressed air flow, and a second plurality of bubble injectors that inject rearward bubbles with respect to the compressed air flow;
a rearward vortex generating ramp configured to deflect the rearward bubbles outward as a rearward vortex into the water and surfactant input flow, the rearward vortex generating ramp in fluid communication with the compressed air input port and the central air manifold to permit a flow of compressed air from the compressed air input port to the central air manifold;
a forward vortex generating ramp configured to deflect the forward bubbles outward as a forward vortex of bubbles into the water and surfactant input flow; and
a flow deflector, attached to the forward vortex generating ramp, the flow deflector having a surface configured to reduce fluid drag as the water and surfactant input flow impinge upon the air bubble injector,
the forward vortex of bubbles turbulently comingling with the rearward vortex of bubbles in the water and surfactant input flow so as to produce a foam output flow having high bubble density, resulting in prolonged drain time when applied to a fire, thereby providing faster fire extinguishment.

9. The air bubble injector of claim 8, wherein the forward vortex generating ramp is curved such that the forward vortex generating ramp has greater slope as a function of distance from the central air manifold.

10. The air bubble injector of claim 8, wherein the rearward vortex generating ramp is curved such that the rearward vortex generating ramp has greater slope as a function of distance from the central air manifold.

11. The air bubble injector of claim 8, wherein the forward vortex generating ramp is curved such that the forward vortex generating ramp has greater slope as a function of distance from the central air manifold.

12. The air bubble injector of claim 8, wherein the rearward vortex generating ramp and the forward vortex generating ramp are mirror images of each other about a central plane of the central air manifold.
